(19) United States
(12) Patent Application Publication
(10) Pub. No.: US 2016/0307057 A1
(43) Pub. Date: Oct. 20, 2016

(54) Fully Automatic Tattoo Image Processing And Retrieval

(71) Applicant: 3M INNOVATIVE PROPERTIES COMPANY, St. Paul, MN (US)

(72) Inventors: Shan Li, Yorba Linda, CA (US); Songtao Li, Arcadia, CA (US)

(21) Appl. No.: 15/132,287

(22) Filed: Apr. 19, 2016

Related U.S. Application Data
(60) Provisional application No. 62/149,910, filed on Apr. 20, 2015.

(51) Int. Cl. G06K 9/00; G06K 9/62; G06F 17/30; G06K 9/46

(52) U.S. Cl. CPC G06K 9/00885; G06K 9/00362; G06K 9/4671; G06K 9/6202; G06F 17/30268; G06F 17/30256

(57) ABSTRACT

A computer implemented system and method for automatically identifying tattoos in captured images. The method includes identifying a skin area within an image; and detecting a plurality of key points within the skin area, wherein the key points are discontinuous points. The method further includes extracting and storing location information and at least one feature for each key point, wherein the stored information describes a tattoo in the skin area.

### TECHNICAL FIELD

The present disclosure relates to the use of tattoo images for identification. More specifically, the present disclosure relates to the automatic processing of tattoo images.

### BACKGROUND

Law enforcement and other agencies or organizations have begun to use tattoo images for the purposes of identification. In order to successfully use a tattoo image for identification purposes, a new tattoo image is compared to a database of existing tattoo images. For identification of a match to the new tattoo image in the existing tattoo database, the tattoo images in the database are typically categorized by labels, so a search can be conducted using keywords to identify potential existing tattoo images that may match the new tattoo image. Unfortunately, categorizing tattoos by keyword can result in randomness and subjectivity due to human annotation, which can lead to too many or too few tattoo images for comparison or not locating an image with the tattoo of interest even though it may exist in the database.

In recent years, there have been a few content-based image retrieval (CBIR) systems proposed in the academic world to fulfill this need. One representative CBIR approach is proposed in “Tattoo-ID: Automatic tattoo image retrieval for suspect and victim identification”, Jain et al., In Proc. IEEE PCM, 2007. This system extracts key-points from tattoo images using a scale invariant feature transform (SIFT) and an unsupervised ensemble ranking algorithm to measure the visual similarity between two tattoo images. The problem with such approaches is that the extraction of SIFT features from a raw image or automatically segmented tattoo image can be highly noisy and inconsistent between two tattoo images. Further, factors such as segmentation errors and image transformations (e.g., blurring, illumination) can all have significant impact on the performance of matching. A more reliable system with higher accuracy and faster computation speed is required for a solution that can be effectively used in law enforcement, commercial or other applications.

### SUMMARY

Tattoos are emerging as a significant biometric feature and joining other biometric features such as fingerprints, iris, etc. as important measures for identification of people or groups of people. Most existing systems in law enforcement contexts rely on human experts to manually match tattoo images between a query and the tattoo image database. Such a process is time and labor consuming. Due to constraints on human resources, a search of a specific tattoo image contained in a large database can also be unrealistic. Therefore an automatic and reliable tattoo image processing and matching system would be highly valuable. The innovative techniques discussed in the present disclosure effectively and automatically detect, extract, process, and retrieve tattoos from a given raw image with high accuracy and real-time computation performance.

The present disclosure describes a fully automatic tattoo image processing and retrieval processing framework. It realizes full automatic capability by providing a complete framework of processing components, including skin detection and tattoo segmentation from a raw image, tattoo edge detection and post-processing, innovative tattoo key point detection and filtering, key point feature extraction, and key-point-based fast tattoo image matching and retrieval. This innovation provides the capability of automatically and effectively identifying people based on their tattoo images taken from a social website page, law enforcement mugshots, or any other image sources under constrained/unconstrained environments. The present disclosure provides a reliable solution for tattoo-based person identification with high accuracy and real-time computation performance.

In one instance, the present disclosure includes a computer implemented method for automatically identifying tattoos in captured images. The method includes identifying a skin area within an image; and detecting a plurality of key points within the skin area, wherein the key points are discontinuous points. The method further includes extracting and storing location information and at least one feature for each key point, wherein the stored information describes a tattoo in the skin area.

In another instance, the present disclosure includes a system for automatically identifying tattoos in captured images. The system includes a processor comprising a skin identification module, a key point detection module and memory. The processor receives an image captured by an optical scanner; and the skin identification module identifies a skin area within an image. The key point detection module detects a plurality of key points within the skin area, wherein the key points are discontinuous points; and the processor extracts and stores location information and at least one feature for each key point in memory, wherein the stored information describes a tattoo in the skin area.

In some instances, the present disclosure further includes comparing the stored location and feature information with stored information for previously processed tattoos to identify an individual.

In some instances, the discontinuous points are at least one of: a bifurcation, an ending, a corner or a cross-point.

In some instances, the skin area is identified by locating a pixel in the image containing a skin tone and identifying adjacent pixels to the pixel containing a skin tone, wherein the skin area includes the pixel and the adjacent pixels.

In some instances, the feature is one of any combination of: color, texture, and orientation information.

In some instances, the present disclosure further includes detecting and storing tattoo edge characteristics.

In some instances, the present disclosure further includes detecting and storing tattoo texture information.

In some instances, the present disclosure further includes storing a picture of the skin area extracted from the image.

In some instances, the present disclosure further includes a post-processing step, wherein the post-processing step is at least one of: broken edge connecting or false edge removing.

### BRIEF DESCRIPTION OF DRAWINGS

The following figures provide illustrations of the present invention. They are intended to further describe and clarify the invention, but not to limit scope of the invention.

FIG. 1 is an exemplary image including a skin area and a tattoo.

FIG. 2 is a flow chart showing a method consistent with the present disclosure.

FIG. 3 is an exemplary skin area identified in the image.

FIG. 4 an exemplary image of key point types and the 3×3 configurations used for key point type comparison/identification.

FIG. 5 is an exemplary identification of key points in an image.

FIG. 6 is an exemplary image of the skin area with a post-processing step applied.

Like numbers are generally used to refer to like components. The drawings are not to scale and are for illustrative purposes only.

### DETAILED DESCRIPTION

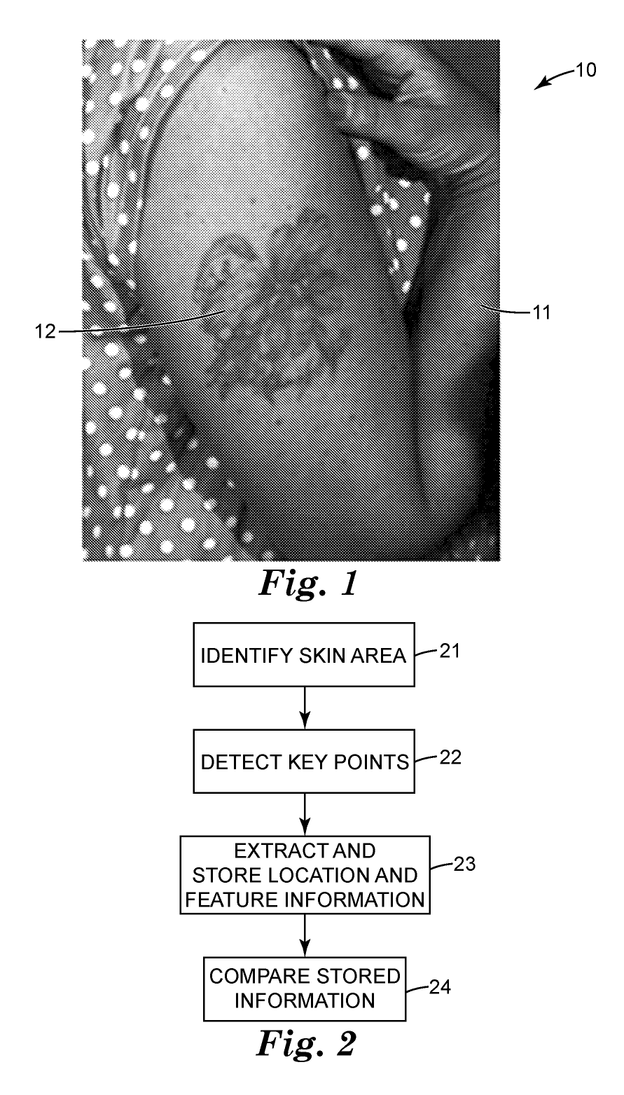

FIG. 1 is an exemplary image 10 that includes a skin area 11 and a tattoo 12. Image 10 may be collected from a source such as an existing database of tattoo images, social website page, law enforcement mugshots, or any other image sources, and may be taken under constrained or unconstrained environments. Image 10 may include any amount of background or other figures in addition to the skin area 11 of the individual featured. A single image 10 may include multiple skin areas belonging to a single person, multiple tattoos 12 in a single or in multiple skin areas, multiple different individuals, and any combination thereof.

FIG. 2 is a flow chart showing a method 20 consistent with the present disclosure. The method discussed in the present disclosure can be implemented on a computing device including a variety of computing functions run by a programmed processor. Computing device comprises one or more computers that include one or more processors, memory, and one or more input/output devices, such as a display screen. The computing device may also include other components and the functions of any of the illustrated components including computer, processor, memory, and input/output devices may be distributed across multiple components and separate computing devices such as in a Cloud computing environment. Computer may be configured as a workstation, desktop computing device, notebook computer, tablet computer, mobile computing device, or any other suitable computing device or collection of computing devices.

The processor may include, for example, one or more general-purpose microprocessors, specially designed processors, application specific integrated circuits (ASIC), field programmable gate arrays (FPGA), a collection of discrete logic, and/or any type of processing device capable of executing the techniques described herein. In some embodiments, memory may be configured to store program instructions (e.g., software instructions) that are executed by processor to carry out the techniques described herein. In other embodiments, the techniques described herein may be executed by specifically programmed circuitry of processor.

Memory may include any volatile or non-volatile storage elements. Examples may include random access memory (RAM) such as synchronous dynamic random access memory (SDRAM), read-only memory (ROM), non-volatile random access memory (NVRAM), electrically erasable programmable read-only memory (EEPROM), and FLASH memory. Examples may also include hard-disk, magnetic tape, a magnetic or optical data storage media, a compact disk (CD), a digital versatile disk (DVD), a Blu-ray disk, and a holographic data storage media.

Input/output device may include one or more devices configured to input or output information from or to a user or other device. In some embodiments, input/output device may present a user interface where a user may control the assessment of biometric data. For example, user interface may include a display screen for presenting visual information to a user. In some embodiments, the display screen includes a touch sensitive display. In some embodiments, user interface may include one or more different types of devices for presenting information to a user. User interface may include, for example, any number of visual (e.g., display devices, lights, etc.), audible (e.g., one or more speakers), and/or tactile (e.g., keyboards, touch screens, or mice) feedback devices. In some embodiments, input/output devices may represent one or more of a display screen (e.g., a liquid crystal display or light emitting diode display) and/or a printer (e.g., a printing device or module for outputting instructions to a printing device). In some embodiments, input/output device may be configured to accept or receive program instructions (e.g., software instructions) that are executed by processor to carry out the techniques described herein. A user may be defined as an individual or agency involved in overseeing security, identification, or law enforcement applications.

The method 20 presumes beginning with an image that includes a skin area, and may or may not include a tattoo. The image may be digital and may be transmitted to a computing device through any communication means which will be known by individuals of skill in the art upon reading the present disclosure. Alternately, if print, or non-digital images are used, the image can be scanned or otherwise converted into a digital format, including pixels, for processing.

Step 21 includes identifying a skin area within the image. The skin area is identified by locating a pixel in the image containing a skin tone, referred to as a seed, and identifying adjacent pixels to the pixel containing a skin tone, generally identified as light or dark, wherein the skin area includes the located pixel and the adjacent pixels. More specifically, multiple skin tones may be used so that pixels representing skin of various tones and shades can be identified. A skin pixel is identified by assigning a probability value to each pixel. A region growing method can be used using the highest probability skin pixel as the seed. The region growing method can also analyze the size of the area identified as skin, compare it with adjacent areas also identified as skin, and decide whether or not to merge the areas into a single skin area. This method allows for identification of a skin area surrounding a tattoo even when a tattoo may divide the skin area into multiple portions. A skin area could be entire image or a portion of the image. A single image can include multiple skin areas.

Step 22 includes detecting a plurality of key points within the skin area. Key points are discontinuous points on tattoo edges and detection of tattoo edges defines key point characteristics. An edge in an image is determined by identifying a significant local change in the image intensity or a measurable variation in color, brightness, or other characteristic, usually associated with a discontinuity in either the image intensity or the first derivative (i.e., slope) of the image intensity. The outer boundary of the tattoo is a type of tattoo edge. In some embodiments, tattoo edges may also be present within the outer boundary of the tattoo and may also be identified. In some embodiments, step 22 may also include detecting and storing tattoo edge characteristics.

During step 22, additional steps may be performed and may include a post-processing step for edge detection. Post processing may include at least one of broken edge connecting or false edge removing. Post processing may be performed after edge detection and before key point detection. Upon conclusion of the post-processing step, key points may be detected and stored for comparison and matching.

The key points are discontinuous points such that they are at least one of: a bifurcation, an ending, a corner or a cross-point. A bifurcation point is present when an edge divides or forks into two branch edges. An ending or end point is present at the beginning or termination of an edge. Corner points are presented when an edge bends or gradually or abruptly changes slope (e.g., positive to negative or negative to positive). And a cross-point is present when two edges intersect. Key points and attributes associated with the key points are used to quantitatively characterize a tattoo or other marking features such as scars or skin abnormalities found in the skin area. Key points may or may not be on a boundary of a tattoo in the image.

In Step 23, feature and location information are extracted and stored for each key point such that the stored information describes a tattoo in the skin area. Feature information includes at least one feature for each point. In some embodiments, multiple pieces of feature information may be stored with respect to a single key point. A feature can be one or any combination of: color, texture and orientation information. Database tattoo images are generally processed offline and their location and feature information are stored in one or multiple databases. Newly captured tattoo images or tattoo images of interest can be processed online. In other variations, any type of data discussed herein may be generally processed either online or offline as will be apparent to one of skill in the art upon reading the present disclosure.

In Step 24, stored information for the particular tattoo image or the tattoo included in the image is compared with previously processed, identified and stored tattoo images to identify an individual. Information can be compared in a variety of ways consistent with the present disclosure. In one embodiment, information is compared using a two stage matcher. In the first stage, the matcher uses a tree structure to compare stored information related to the image being processed to stored information for images in an existing database. In a second stage, the matcher can use any of several statistical approaches to find all images in the database with the most similar key points to the image being processed. Some of these statistical approaches include a KNN (K-Nearest Neighbor) search, a RANSAC (Random Sample Consensus) search and other search and matching techniques which will be apparent to one of skill in the art upon reading the present disclosure.

Other specific steps and combinations of steps may be used consistent with the present disclosure. For example, in one embodiment, identifier levels of varying complexity may be used to refine search results for matches of a tattoo image. A first level may be key points and related features. A second (and more complex level) may be boundary characteristics. And a third level (and most complex level) may be image texture. Texture information can include spatial information or can include information in the frequency domain characterizing the tattoo. Such information can be analyzed within the frequency domain to allow for additional computational approaches to matching solutions consistent with the present disclosure.

Each of these levels may be used successively if the previously level did not provide sufficiently narrowed search results. However, in some embodiments, the higher a level that is used to generate search results, the more data and computational capacity is required.

The tattoo image may also be stored and analyzed at a later interval when computational resources become or are available to compare at the third level.

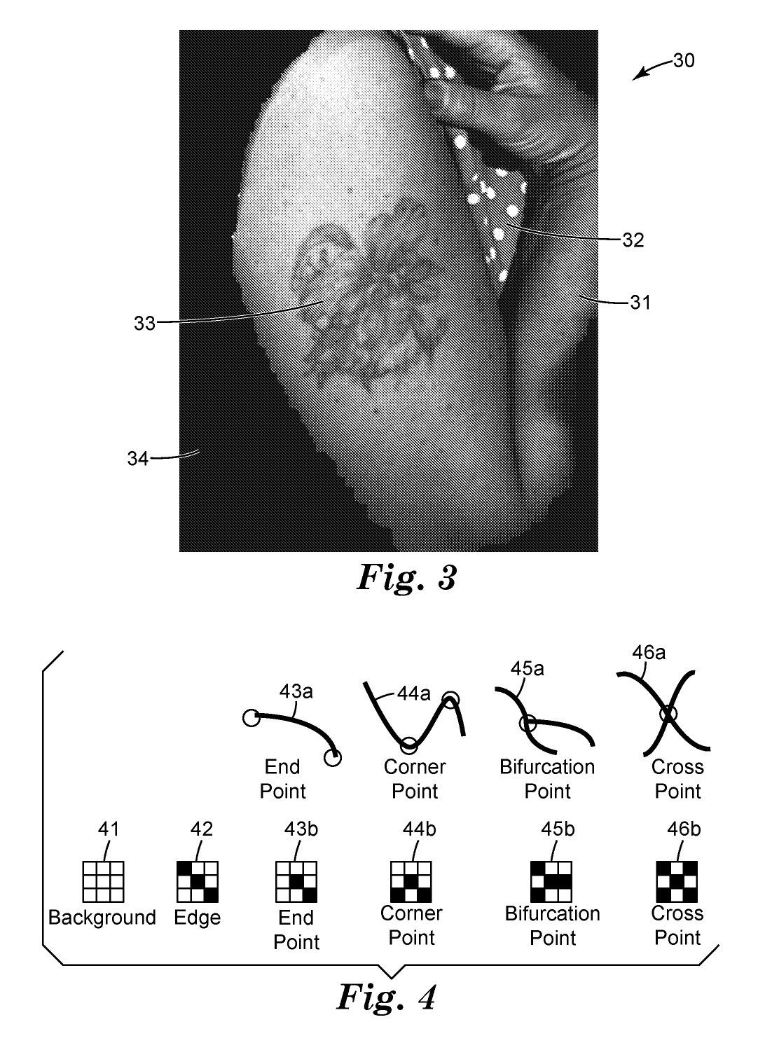

FIG. 3 is an exemplary skin area 31 identified in the image 30 with the background 34 removed. Skin area 31 includes tattoo 33. Additionally, skin area has been identified as a single continuous skin area in this particular image because of the connection between the individual's thumb and arm in this image. As a result, a portion of the individual's shirt 32 that was surrounded by this skin area was also retained in the image 30.

FIG. 4 is an exemplary image of key point types and the 3×3 pixel configurations that can be used for key point type identification and comparison. Each box in the matrices shown in FIG. 4 can represent a single pixel or multiple pixels. Matrix 41 shows a pixel matrix that can be used to identify background area. Matrix 41 shows an instance where a set of surrounding pixels have the same or similar color, hue or value.

Matrix 42 shows a pixel matrix that can be used to identify an edge. The pixels in matrix 42 include multiple continuous pixels of a same or similar color, hue or value, represented by dark pixels in matrix 42. The dark pixels, representing an edge, surrounded by pixels of a different color hue or value, which are represented by white pixels in matrix 42. In matrix 42, the edge is headed in a single direction.

Line 43a is an example of a line with two end points. Each end point is identified by a circle. Matrix 43b shows a pixel matrix that can be used to identify an end point. An end point is illustrated by at least two continuous pixels of a same or similar color, hue or value, represented by dark pixels in matrix 43b, where at least one of the two continuous pixels is surrounded on three sides by pixels of different color, hue or value.

Line 44a is an example of a line with two corner points. The corner points on line 44a are identified by circles. Matrix 44b shows a pixel matrix that can be used to identify a corner point. A corner point is illustrated by at least three continuous pixels of a same or similar color, hue or value, represented by dark pixels in matrix 44b, where the continuous change direction is at least one point.

Line 45a is an example of lines creating a bifurcation point. The bifurcation point is identified by a circle. Matrix 45b shows a pixel matrix that can be used to identify a bifurcation point. A bifurcation point is illustrated by a series of at least three continuous pixels of a same or similar color, hue or value, represented by dark pixels in matrix 45b, where at least a fourth pixel of a same or similar color, hue or value is adjacent to at least one of the three pixels, but not continuous with the three pixels.

Line 46a is an example of lines creating a cross point. The cross point is identified by a circle. Matrix 46b shows a pixel matrix that can be used to identify a cross point. A cross point is illustrated by a series of at least three continuous pixels of a same or similar color, hue or value, represented by dark pixels in matrix 46b, where the three continuous pixels are intersected by a second set of three continuous pixels of the same or similar color, hue or value, and where the first set of three continuous pixels and the second set of three continuous pixels share one or at least one pixels.

While the images in FIG. 4 show an example of a variety of types of key points that can be identified along with pixel matrices that can be used to identify them, other types of key points other than those illustrated will be apparent to one of skill in the art upon reading the present disclosure, and are within the scope of the present invention. Additionally, alternative methods of identifying key points will be apparent to one of skill in the art upon reading the present disclosure and are within the scope of the present invention.

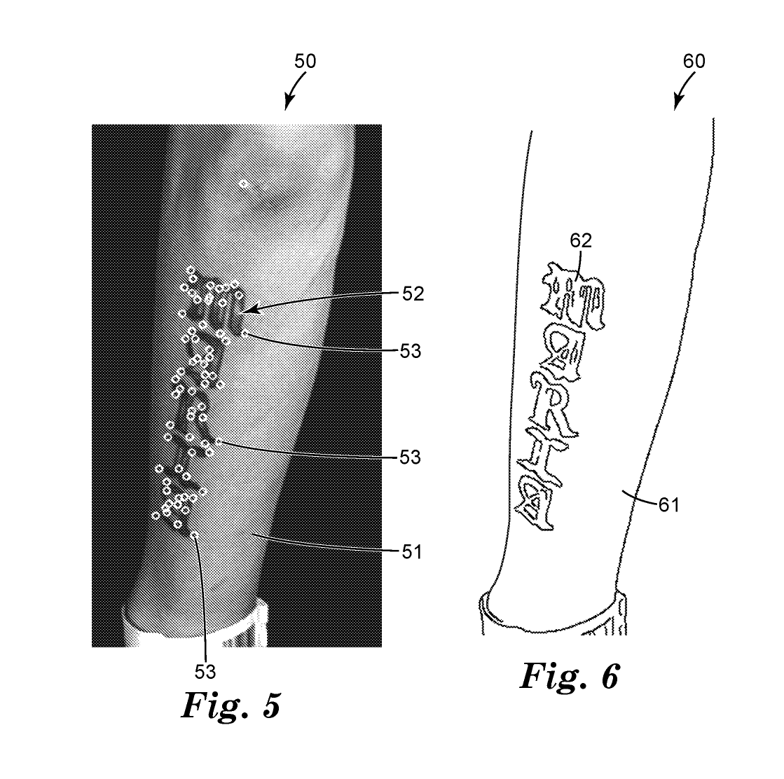

FIG. 5 is an exemplary identification of key points in image 50. Image 50 is a photograph of an individual's leg. The background has already been extracted from image 50, leaving the skin area, including the tattoo 52 shown on leg 51. Points 53 are examples of key points that were identified when automatically processing the image 50 according to the present disclosure.

FIG. 6 is an exemplary image 60 of the skin area 61 with a post-processing step applied. A variety of post-processing steps can be used in accordance with the present disclosure at various processing modules, such as skin detection, edge and key point detection. For example, post processing steps can include: broken edge connecting or false edge removing. In the FIG. 6, a broken edge connecting post-processing step was applied to tattoo 52. This post-processing step identified separate lines forming a continuous direction that were likely to be part of a single continuous line in the actual tattoo, and connected the separate lines to form a single continuous line.

Other post-processing steps that can be used consistent with the present disclosure will be apparent to one of skill in the art upon reading the present disclosure.

### Example

### Skin Based Automatic Tattoo Segmentation and Recognition

Rapid and accurate recognition of tattoos present challenges due to the complexities of the multitude of shapes, patterns, colors, and/or textures, which they may be assembled and furrowed into skin. The inks and pigments used to etch tattoos are deeply embedded and are typically difficult to remove and/or destroy. As a consequence, tattoos have become a conduit to identify individuals in situations of trauma or forensic investigation. Provided that a tattoo is exposed and visible, automatic recognition may be used to identify persons of interest such as those involved in criminal activity. Factors such as the ambient light conditions or illumination level and position of a camera when an image of a tattoo is captured may also impact recognition speed and accuracy. Once an image is captured and stored, transformation of the captured images including pose, translation, rotation, and scaling also lead to difficulties in accurately recognizing tattoos and consequently identifying the person.

In order to effectively recognize a tattoo and correspondingly identify a person who is engraved with it, captured images require segmentation, extraction and detection of key points and their features, and matching to one or more previously processed images of the tattoo.

Segmentation began with a raw, unstrained captured image that included a visible tattoo and other background information including the skin and clothing of the person. The captured image was obtained from a gallery (e.g., The Smoking Gun, 2014, Retrieved from the Internet <URL: www.thesmokinggun.com/mugshots/general/tattoos> of tattoo images that are available online. The image was stored and foreground segmentation was applied to the image to remove specific portions of the background that may not contain representations of skin. Foreground segmentation involved firstly applying two models to determine if regions of skin, contained in the image, could be identified and subsequently classified as a light or dark skin tone. The models analyzed one or more individual pixels within the image and assigned probabilities as to whether the tone of the pixel was light skin, dark skin, or non-skin. Pixels assigned with high probabilities of light skin or dark skin tone are identified as skin pixels and referred as seeds. Next, the neighborhood surrounding the identified skin pixel (i.e., seed) was statistically analyzed, using probability (k-nearest neighbor), area, and/or distance threshold techniques, to detect neighboring pixels whose tones were similar to the seed and may thereafter also be identified as skin pixels.

During segmentation, image enhancement occurred and the boundary or edges of the tattoo were located based upon transitions between skin tone and/or color changes within the tattoo. Canny edge extraction was used to automatically determine the most distinguishable features and locate the edges of the tattoo. Before Canny edge extraction was implemented, the segmented tattoo image was smoothed by applying a Gaussian filter to remove potential noise. Intensity gradients (e.g., magnitude and direction) were calculated by locating regions within an image where the brightness changed abruptly or sharply. Once the edges were located, a thinning technique known as non-maximum suppression was used to remove falsely detected edges by comparing the strength of the pixel in more or gradient directions. Identified edges were subsequently classified as strong, weak or false based upon comparison against hysteresis thresholds. For the purpose of handling possible uneven illumination and/or blurring of tattoo boundaries in tattoo images, adaptive high and low hysteresis thresholds were calculated locally around each pixel. In specific, distribution of gradient magnitude was calculated for a window centered at each pixel. Hysteresis thresholds were adaptively calculated to minimize the variance of gradient magnitude among edge pixels and to maximize the variance between edge and non-edge pixels in the local window. Extraction concluded by identifying strong and weak edges that linked to strong edges as real edges, and suppressing or removing weak isolated and false edges. Post processing is further applied to link broken edges and to remove false edges.

Key points on or within the boundary or edges were identified and filtered. The key points included end, bifurcation, turning, and cross points. Detection began by matching a pixel of interest to a stored 3×3 configuration that represented one of the key point types. FIG. 6 provides a representation of the 3×3 pixel configurations. The edges were traced and continually compared to the 3×3 configurations to identify key point locations and their types. False key points were removed if the trace length of the edges connected to the key point of interest were too short. For example, if an endpoint on an edge is initially located and upon continuation of the trace another endpoint is found within a short trace length, both end points are removed. Quality of the key point types was estimated based upon trace length, angles between edges that connect to the key point of interest, and relative proximity to other key points. Once the key points were identified, scale, rotation and translation invariant features were extracted from the image surrounding the points. Extracted features included location (e.g., relative x, y coordinates), inter-relationship between key points (e.g., relative distance and/or angles), color, texture, and orientation.

The extracted features were then matched and compared to previously processed images of tattoos using a two-stage matcher. The performance was measured against a scale invariant feature transform (SIFT) key point detection approach. In the first stage, a kd-tree was previously assembled which stored the features of all key points of the database images in the kd-tree structure. Every key point in the captured image was then matched and compared against all key points in the kd-tree using their respective features. The top number of images that have the most number of matched key points were returned as the candidate matches. The first stage of the matcher is fast and matched the captured image against a large database very quickly. In the second stage, a combination of K-nearest neighbor (KNN), symmetry, and random sample consensus (RANSAC) techniques were used to identify true matches among all candidate matches. The second stage of the matcher is time extensive but identified true matches with high accuracy. Since the first stage matcher greatly reduced the amount of candidates for the second stage, the two stage matcher was able to efficiently and accurately identify matches in large databases. Table 1 provides a comparative summary against the SIFT detection approach in a testing database comprising 750 tattoo images. Accuracy is defined as how often the true match of the captured tattoo image appeared in the top 10 matches during matching. For example, using the SIFT detection approach with 200 key points and 128 features per key point resulted in locating a match in the top 10 four out of ten times.

TABLE 1
Key Point Detection Comparison

| Detection Approach | # of Key Points | # of Features | Accuracy |
|---|---|---|---|
| SIFT | 200 | 128/key point | 40% |
| SIFT | 400 | 128/key point | 51% |
| Skin Based | 200 | 128/key point | 53% |
| Skin Based | 400 | 128/key point | 70% |

The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

What is claimed is:

1. A computer implemented method for automatically identifying tattoos in captured images, the method comprising:
identifying a skin area within an image;
detecting a plurality of key points within the skin area, wherein the key points are discontinuous points; and
extracting and storing location information and at least one feature for each key point, wherein the stored information describes a tattoo in the skin area.

2. The method of claim 1, further comprising comparing the stored location and feature information for the tattoo with stored information for previously processed tattoos to identify an individual.

3. The method of claim 1, wherein the discontinuous points are at least one of: a bifurcation, an ending, a corner or a cross-point.

4. The method of claim 1, wherein the skin area is identified by locating a pixel in the image containing a skin tone and identifying adjacent pixels to the pixel containing a skin tone, wherein the skin area includes the pixel and the adjacent pixels.

5. The method of claim 1, wherein the feature is one of any combination of: color, texture, and orientation information.

6. The method of claim 1, further comprising detecting and storing tattoo edge characteristics.

7. The method of claim 1, further comprising detecting and storing tattoo texture information.

8. The method of claim 1, further comprising storing a picture of the skin area extracted from the image.

9. The method of claim 1, further comprising a post-processing step, wherein the post-processing step is at least one of: broken edge connecting or false edge removing.

10. A system for automatically identifying tattoos in captured images, the system comprising:
a processor comprising a skin identification module, a key point detection module and memory;
wherein the processor receives an image captured by an optical scanner;
wherein the skin identification module identifies a skin area within an image;
wherein the key point detection module detects a plurality of key points within the skin area, wherein the key points are discontinuous points; and
wherein the processor stores location information and at least one feature for each key point in memory, wherein the stored information describes a tattoo in the skin area.

11. The system of claim 10, wherein the processor compares the stored location and feature information for the tattoo with stored information for previously processed tattoos to identify an individual.

12. The system of claim 10, wherein the discontinuous points are at least one of: a bifurcation, an ending, a corner or a cross-point.

13. The system of claim 10, wherein the skin area is identified by locating a pixel in the image containing a skin tone and identifying adjacent pixels containing a skin tone.

14. The system of claim 10, wherein the feature is one of or any combination of: color, texture, and orientation information.

15. The system of claim 10, wherein the processor detects and stores tattoo edge characteristics.

16. The system of claim 10, wherein the processor detects and stores image texture information.

17. The system of claim 10, wherein the processor stores a picture of the skin area extracted from the image in memory.

18. The system of claim 10, wherein the processor completes a post-processing step, wherein the post-processing step is at least one of: broken edge connecting or false edge removing.
